(19) United States
(12) Patent Application Publication
(10) Pub. No.: US 2011/0082999 A1
(43) Pub. Date: Apr. 7, 2011

(54) DATA PROCESSING ENGINE WITH INTEGRATED DATA ENDIANNESS CONTROL MECHANISM

(75) Inventor: Chi-Chang Lai, Taichung County (TW)

(73) Assignee: ANDES TECHNOLOGY CORPORATION, Hsin-Chu City (TW)

(21) Appl. No.: 12/575,468

(22) Filed: Oct. 7, 2009

(51) Int. Cl. G06F 12/02

(52) U.S. Cl. 711/201; 711/E12.002

(57) ABSTRACT

A data processing engine is provided, which includes an endian register, an endian control device, and a byte swapper. The endian register stores a plurality of endian control bits. Each endian control bit indicates the default data endianness of a type of address space accessible to the data processing engine. Each endian control bit is in either a big-endian state or a little-endian state. The endian control device is coupled to the endian register. The endian control device provides an endian signal according to the endian control bits and the instruction executed by the data processing engine. The endian signal is in either the big-endian state or the little-endian state. The byte swapper is coupled to the endian control device. The byte swapper transmits data and changes the byte order of the data when the byte order of the data is inconsistent with the state of the endian signal.

### BACKGROUND OF THE INVENTION

1. Field of the Invention

The present invention relates to a data endianness control mechanism. More particularly, the present invention relates to a data endianness control mechanism integrated in a data processing engine.

2. Description of the Related Art

A conventional data processing engine (such as a general purpose microprocessor) may access one or more address spaces. Each address space may be used to access either memory or I/O devices, or both. The address spaces of memory and I/O devices may be separated by different load/store instructions. For example, the instruction LoadMemory is used to access the memory address space, while the instruction LoadIO is used to access the I/O address space. Alternatively, the address spaces of memory and I/O devices may be separated according to physical address space segments (without address translation) or virtual address space segments (with address translation). Each segment has a different address range.

In the field of computer architecture, the term data endianness is the interpretation of data byte order for putting a sequence of byte data into a destination storage (such as register, memory, or data bus) that has data width more than one byte. The big-endian order and the little-endian order are the most common. FIG. 1 is a schematic diagram showing the conventional concepts of big-endian byte order and little-endian byte order. FIG. 1 shows a little-endian byte order 110, a big-endian byte order 120, and a memory 150 storing data bytes D0-D11. According to the little-endian byte order 110, the data byte D0 from the lowest address of the memory 150 is put on the least significant byte (LSB) of the destination storage, while data bytes with higher addresses go toward the most significant side of the destination storage. According to the big-endian byte order 120, the data byte D0 from the lowest address of the memory 150 is put on the most significant byte (MSB) of the destination storage, while data bytes with higher addresses go toward the least significant side of the destination storage.

Due to differences among hardware implementations, different address spaces may use different data endiannesses. For example, the personal computer (PC) uses little-endian byte order, while network transmission uses big-endian byte order. This makes endian conversion necessary. The endian conversion of storage data is the conversion of data byte order when the data is transferred from one storage place to another, while the source place and the destination place are constructed with different data size units. For example, data endian conversion is required for data transfer between a 32-bit register and a byte-addressable memory. The data endianness determines which byte of the 32-bit register (the least significant byte or the most significant byte) is to be written to or read from the first byte address of the memory.

A data processing engine that supports bi-endian data processing usually uses one of the following mechanisms to control the data endian conversion.

The first control mechanism is separate load/store instructions. One set of instructions is used to perform big-endian load/store operations, while the other set is used to perform little-endian load/store operations.

The second control mechanism is specific endian conversion instructions. One set of specific instructions is used to convert data endianness when the data is stored in a register.

The third control mechanism is using a dedicated software-programmable endian control register to determine the endianness for all load/store operations. The control register stores a single bit, whose value determines the current endianness for all load/store operations. The software can change the bit value to switch between big-endian byte order and little-endian byte order.

The fourth control mechanism is separate physical address ranges for different endiannesses. At least one address range is for big-endian load/store accesses, while another address range is for little-endian load/store accesses. For example, the address range 0000h-BFFFh is assigned to little-endianness and the address range C000h-FFFFh is assigned to big-endianness, wherein the trailing “h” means hexadecimal number.

All of the aforementioned conventional control mechanisms treat address spaces for memory and I/O devices in the same way. None of the conventional control mechanisms differentiate between memory address space and I/O address space.

### SUMMARY OF THE INVENTION

Accordingly, the present invention is directed to a data processing engine with integrated data endianness control mechanism. The data processing engine stores a plurality of programmable endian control bits. By programming the states of the endian control bits, the data endianness of each address space type can be set independently. The address space type of each data transfer may be determined by types of instructions, range of address spaces, or attribute of address spaces. This control mechanism features more flexible data endianness management and easier software development.

According to an embodiment of the present invention, a data processing engine is provided. The data processing engine includes an endian register, an endian control device, and a byte swapper. The endian register stores a plurality of endian control bits. Each endian control bit indicates the default data endianness of a type of address space accessible to the data processing engine. The types of address spaces may be as simple as one memory space and one device space, or as comprehensive as multiple memory spaces and multiple device spaces. Each endian control bit is in either a big-endian state or a little-endian state. The endian control device is coupled to the endian register. The endian control device provides an endian signal according to the endian control bits and the instruction executed by the data processing engine. The endian signal is in either the big-endian state or the little-endian state. The byte swapper is coupled to the endian control device. The byte swapper transmits the data used or generated by the instruction and changes the byte order of the data when the byte order of the data is inconsistent with the state of the endian signal.

When a predetermined condition is true, the data processing engine may save the endian control bits into a storage device, such as a processor status word register, load a plurality of default values into the endian register as new endian control bits, execute a predetermined process, and then restore the previous endian control bits from the storage device to the endian register. For example, the predetermined condition may be the occurrence of an exception and the predetermined process may be the exception handler.

The data processing engine may further include a space decoder. The space decoder is coupled to the endian control device. The space decoder decodes the instruction and/or its associated address and provides a decoder signal based on the decoding result. The decoder signal determines one type of the address spaces and the endian control device uses it to select and output the endian control bit corresponding to the determined address space type as the endian signal.

The data processing engine may further implement a plurality of attributes for each segment of address space, where the attributes represent more fine-grained type of address space. The endian control device may output the endian signal according to the address space attributes. These kinds of attributes may be implemented in virtual address space level or physical address level or both. The attributes may determine at least but not limited to one of cacheability, bufferability, and coalesceability for the associated address space segment.

The combined value of the address space attributes may be corresponding to one of the address space types and the endian control device may output the endian control bit corresponding to the one of the address space types as the endian signal.

Each segment of address space may further include an endian selection attribute which is in the big-endian state, the little-endian state, or a disabled state. In this case, the endian control device outputs the endian signal according to the state of the endian selection attribute when the endian selection attribute is in the big-endian state or the little-endian state. The endian control device outputs the endian signal according to the combined value of the address space attributes when the endian selection attribute is in the disabled state.

The instruction may be one of a plurality of software programmable instructions or some implicit hardware operations of a current process that performs load or store operation from or to an address, and the endian control bits, the address space attributes, and the endian selection attribute may be context-switchable with the current process.

When the instruction accesses to a data across a first one and a second one of the address spaces simultaneously and addresses of the second address space are higher than those of the first address space, the endian control device may output the endian control bit corresponding to either the first address space or the second address space, but not both, as the endian signal. Alternatively, the data processing engine may raise an exception.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing the conventional concepts of big-endian byte order and little-endian byte order.

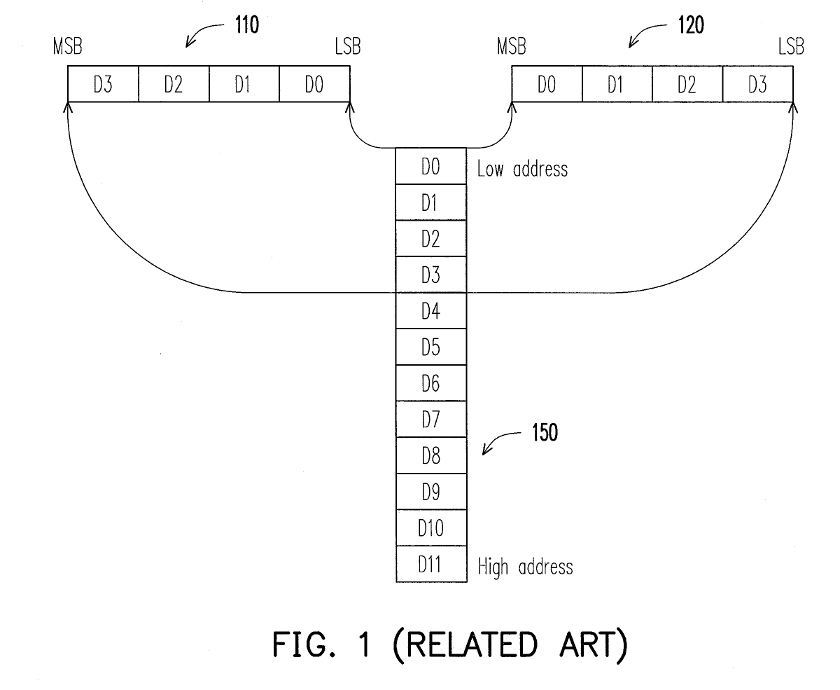

FIG. 2 is a schematic diagram showing a part of a data processing engine implementing a data endianness control mechanism according to an embodiment of the present invention.

FIG. 3 is a schematic diagram showing a part of another data processing engine implementing another data endianness control mechanism according to another embodiment of the present invention.

FIG. 4 is a flow chart of a method for controlling data endianness executed by the endian control device in FIG. 3.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

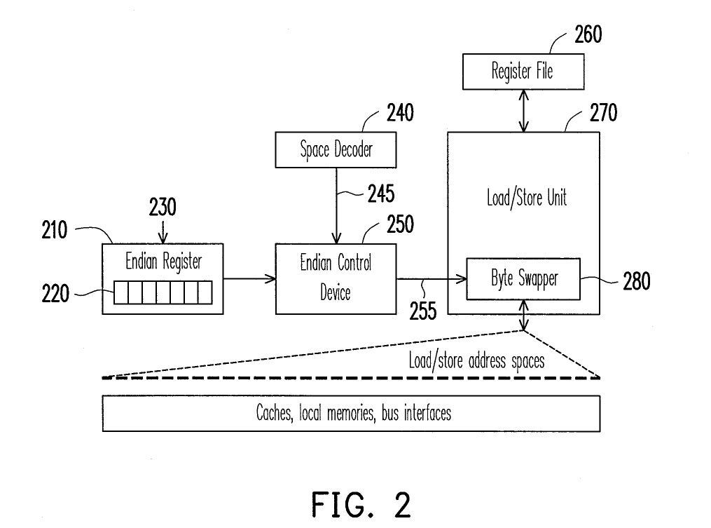

FIG. 2 is a schematic diagram showing a part of a data processing engine according to an embodiment of the present invention. The data processing engine includes an endian register 210, a space decoder 240, an endian control device 250, a register file 260, a load/store unit 270. The load/store unit 270 includes a byte swapper 280.

The load/store unit may be a regular function unit of a data processing engine that executes the load/store instructions programmed by user of the engine, or an implicit data movement function operated by the engine to access certain non-instruction specified data, such as translation look-aside buffer data or debugging data.

The endian register 210 stores a plurality of endian control bits 220. Each of the endian control bits 220 indicates the data endianness of a type of address space accessible to the data processing engine. Each of the endian control bits 220 is in either a big-endian state or a little-endian state. For example, the bit value 1 may represent the big-endian state and the bit value 0 may represent the little-endian state. Alternatively, the bit value 1 may represent the little-endian state and the bit value 0 may represent the big-endian state.

The space decoder 240 decodes the instruction executed by the data processing engine and/or its associated address and provides a decoder signal 245 based on the decoding result. Each value of the decoder signal 245 determines one type of the address spaces. The endian control device 250 is coupled to the endian register 210 and the space decoder 240. The endian control device 250 outputs the endian control bit corresponding to the type of address space determined by the value of decoder signal 245 as an endian signal 255. Similar to the endian control bits 220, the endian signal 255 is in either the big-endian state or the little-endian state.

The register file 260 includes many internal registers of the data processing engine. The load/store unit 270 handles the load/store operation between the internal registers of the register file 260 and the address spaces. The address spaces of the data processing engine may be used to access caches, local memories, or bus interfaces leading to external memories or registers of I/O devices. The byte swapper 280 is coupled to the endian control device 250, the register file 260, and the aforementioned hardware components access by the address spaces. The byte swapper 280 transmits the data used or generated by the operation between the internal registers of the register file 260 and the aforementioned hardware components. In addition, the byte swapper 280 changes the byte order of the data when the byte order of the data is inconsistent with the state of the endian signal 255.

In order to effectively control data endianness, the byte swapper 280 knows the hardware implementation of all the internal registers, caches, local memories, external memories, and I/O devices, including the locations of the most significant bytes and the least significant bytes. As a result, the byte swapper 280 can determine whether the data byte order is consistent with the endian signal 255 or not.

The states of the endian control bits 220 may be set by software executed by the data processing engine. Since the data endianness of each type of address space is controlled by a corresponding endian control bit, the data endianness of each type of address space can be controlled independently. For example, one type of the address spaces may be used to access the memories coupled to the data processing engine and another one type of the address spaces may be used to access registers of the I/O devices coupled to the data processing engine. Due to this arrangement, the software can control data endianness of the memory address spaces and the I/O address spaces according to different rules.

The types of address spaces may be differentiated by instruction type or address range. When the differentiation is based on instruction type, several sets (or types) of instructions may be used to access one type of address spaces. The space decoder 240 provides the decoder signal 245 according to the set/type of the instruction. When the differentiation is based on address range, one type of address space is assigned to an address range, while multiple of address ranges may be set to the same address space type. In this case, the space decoder 240 provides the decoder signal 245 according to the address space type accessed by the instruction. The decoder signal 245 determines the type of the address spaces whose address range includes the memory address accessed by the instruction.

The endian register 210 receives a plurality of default values 230. Each endian control bit 220 has a corresponding default value 230. When a predetermined condition is true, the data processing engine saves the endian control bits 220 into a temporary storage device (not shown), replaces the endian control bits 220 with the default values 230, executes a predetermined process, and then restores the previous endian control bits 220 from the temporary storage device to the endian register 210. For example, the predetermined condition may be the occurrence of hardware reset, an exception, a trap, a fault, or an interrupt, which brings the data processing engine into a superuser or privileged state, or similar known state. The predetermined process may be the handler process of the exception, trap, fault, or interrupt. In the superuser state or the privileged state, the endian control bits 220 needs to be constant control values to ensure correct system behavior. The default values 230 provide the constant control values in the superuser state or the privileged state. The default values 230 may further be implemented as external pin selections of the data processing engine chip so that the default values 230 can be adjusted through jumpers on the circuit board on which the data processing engine chip is mounted.

In some rare events, the load/store operation of the instruction accesses a data across two address spaces simultaneously. For example, the accessed data word may extend beyond the boundary of an address space segment into another address space segment. In this case, the space decoder 240 may output the decoder signal 245 to select the address space segment with either the lower addresses or the higher addresses so that the endian control device 250 outputs the unique endian control bit corresponding to the address space segment with either the lower addresses or the higher addresses as the endian signal 255, respectively. Alternatively, the space decoder 240 may raise an exception if the implementation intends not to handle this case in the decoder.

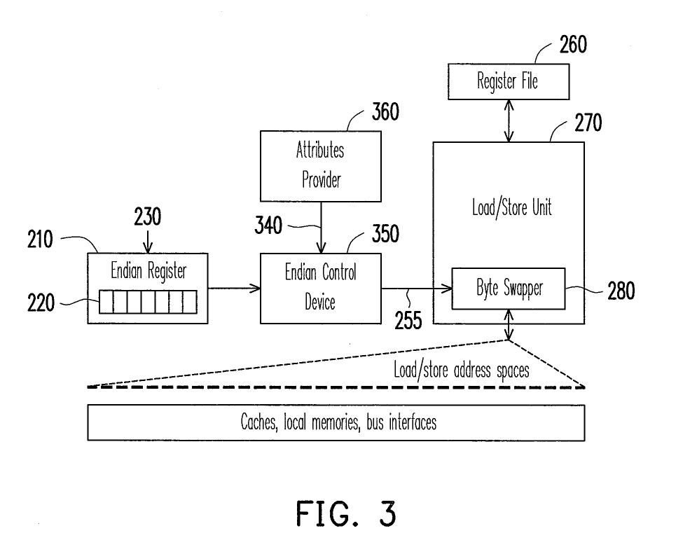

FIG. 3 is a schematic diagram showing a part of another data processing engine according to another embodiment of the present invention. The space decoder 240 and the endian control device 250 in FIG. 2 are replaced with the attributes provider 360 and the endian control device 350, respectively. The attributes provider 360 and the endian control device 350 are coupled to each other. The other components in FIG. 3 are the same as their counterparts in FIG. 2.

In the embodiment of FIG. 3, the address space segments accessed by the data processing engine are divided into segments of physical address spaces or virtual address spaces. Each segment is associates with one or more address space attributes and an endian selection attribute. The address space attributes may determine the cacheability, bufferability, and/or coalesceability of associated address space segment, or other ability restrictions for regular load/store operations (well known knowledge so hence details are omitted here). The endian selection attribute is in the big-endian state, the little-endian state, or a disabled state. The attributes provider 360 may store a table which includes the address space attributes and the endian selection attributes of all the address space segments. When the data processing engine executes an instruction, the attributes provider 360 decodes the instruction and looks up the aforementioned table based on the decoding result. The attributes provider 360 provides the address space attributes and the endian selection attribute corresponding to the address space segment accessed by the instruction as the attributes 340 to the endian control device 350. The endian control device 350 outputs one of the endian control bits 220 as the endian signal 255 according to the attributes 340.

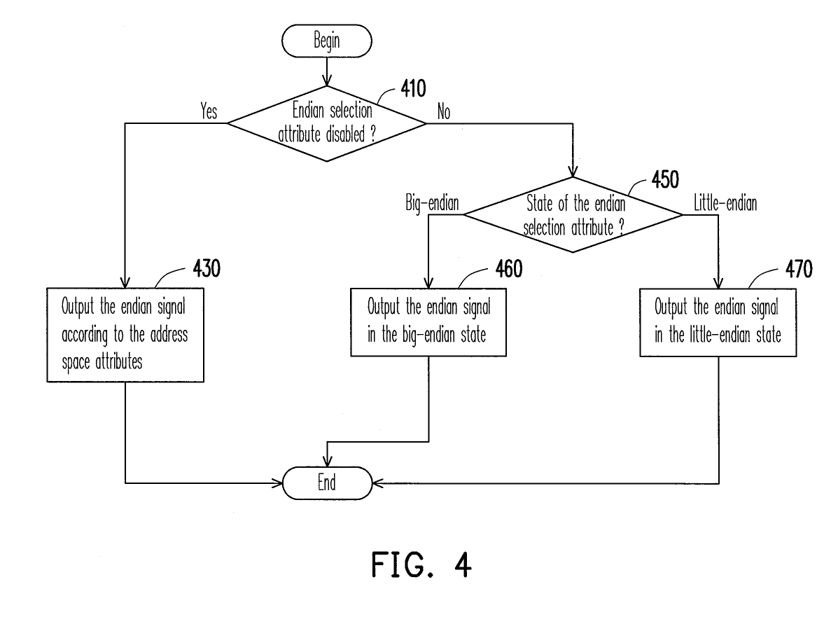

FIG. 4 is a flow chart of a method for controlling data endianness executed by the endian control device 350. First, check whether the endian selection attribute of the address space segment accessed by the instruction is in the disabled state or not (step 410). If the endian selection attribute is not disabled, check whether the endian selection attribute is in the big-endian state or the little-endian state (step 450). If the endian selection attribute is in the big-endian state, the endian control device 350 outputs the endian signal 255 in the big-endian state (step 460). If the endian selection attribute is in the little-endian state, the endian control device 350 outputs the endian signal 255 in the little-endian state (step 470).

Back in step 410, if the endian selection attribute is disabled, the endian control device 350 outputs the endian signal 255 according to the combined value of the aforementioned address space attributes, which determine the cacheability, bufferability, and/or coalesceability of the address space segment accessed by the current instruction (step 430).

For example, (non-cacheable, non-bufferable, non-coalesceable) is a combined value of the address space attributes, while (cacheable, bufferable, non-coalesceable) is another combined value of the address space attributes. Each address space attribute has an affirmative state and a negative state. In total, there are eight binary combinations of the states corresponding to eight combined values of the address space attributes. Each of the eight combined values is representing one type of address spaces accessible to the data processing engine. When the data processing engine executes an instruction and the instruction performs a load/store operation, the endian control device 350 receives the address space attributes of the address space segment accessed by the load/store operation. The combined value of the address space attributes is used to select one of the endian control bits 220. Accordingly, the endian control device 350 outputs the endian control bit corresponding to the aforementioned combined value as the endian signal 255.

A simple example when only two endian control bits are implemented is applying the first endian control bit to a segment of address space with non-cacheable, non-bufferable, and non-coalesceable attributes and applying the second endian control bit to another segment of address space with the other combined values of the attributes. In a general implementation, the address space attributes may be set by the operating system or even other application software to control the data endianness of each address space segment.

Whether the attributes used for selecting endian control bit is associated to physical address space or virtual address space depends on the address translation function of the data processing engine. If the address translation function is disabled, the load/store operations are based on physical addresses and the attributes of physical address segment are used. If the address translation function is enabled, the load/store operations are based on virtual addresses and the attributes of virtual memory segment are used.

Each of endian control bits 220 represents the default data endianness of a type of address space according the combined value of associated address space attributes. The endian selection attribute may be used to override the default data endianness for each individual address space segment. In other words, the endian control bits 220 provide coarse-grained data endianness control while the endian selection attributes of the address space segments provide fine-grained data endianness control. In some other embodiments of the present invention, the endian selection attribute may be omitted to provide a simplified data endianness control mechanism.

In a multi-process computer system, context-switching is both conventional and mandatory. All of the endian control bits, the address space attributes, and the endian selection attribute may be context-switchable with the current process executed by the data processing engine. When the operating system switches to another process, the endian control bits, the address space attributes, and the endian selection attribute may be saved to the context of the current process. When the operating system switches back to the current process, the endian control bits, the address space attributes, and the endian selection attribute may be restored from the context of the current process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data processing engine, comprising:
an endian register, storing a plurality of endian control bits, wherein each of the endian control bits indicates a default data endianness of a type of address space accessible to the data processing engine, each of the endian control bits is in either a big-endian state or a little-endian state;
an endian control device, coupled to the endian register, providing an endian signal according to the endian control bits and an instruction executed by the data processing engine, wherein the endian signal is in either the big-endian state or the little-endian state; and
a byte swapper, coupled to the endian control device, transmitting a data used or generated by the instruction and changing a byte order of the data when the byte order of the data is inconsistent with the state of the endian signal.

2. The data processing engine of claim 1, wherein the data processing engine loads a plurality of default values into the endian register as the endian control bits when a predetermined condition is true.

3. The data processing engine of claim 2, wherein when the predetermined condition is true, the data processing engine saves the endian control bits into a storage device, loads the default values into the endian register as the new endian control bits, executes a predetermined process, and then restores the previous endian control bits from the storage device to the endian register.

4. The data processing engine of claim 1, wherein at least one of the types of address spaces is used to access a memory coupled to the data processing engine and at least another one of the types of address spaces is used to access registers of I/O devices coupled to the data processing engine.

5. The data processing engine of claim 1, further comprising:
a space decoder, coupled to the endian control device, decoding the instruction and/or its associated address and providing a decoder signal based on the decoding result, wherein the decoder signal determines one type of the address spaces and the endian control device uses the decoder signal to select and output the endian control bit corresponding to the determined address space type as the endian signal.

6. The data processing engine of claim 5, wherein the space decoder provides the decoder signal according to a type of the instruction.

7. The data processing engine of claim 5, wherein the space decoder provides the decoder signal according to a range an address accessed by the instruction falls into and the decoder signal selects the type of the address spaces for the address range which comprises the address.

8. The data processing engine of claim 1, wherein the instruction accesses an address within an address space segment, the address space segment comprises a plurality of address space attributes, the endian control device outputs the endian signal according to the address space attributes.

9. The data processing engine of claim 8, wherein a combined value of the address space attributes is corresponding to one of the types of the address spaces and the endian control device outputs the endian control bit corresponding to the one type of the address spaces as the endian signal.

10. The data processing engine of claim 8, wherein the address space segment is a physical address segment or a virtual address segment.

11. The data processing engine of claim 8, wherein the address space attributes determine at least one of cacheability, bufferability, and coalesceability of the address space segment.

12. The data processing engine of claim 8, wherein the address space segment further comprises an endian selection attribute which is in the big-endian state, the little-endian state, or a disabled state; the endian control device outputs the endian signal according to the state of the endian selection attribute when the endian selection attribute is in the big-endian state or the little-endian state; the endian control device outputs the endian signal according to the address space attributes when the endian selection attribute is in the disabled state.

13. The data processing engine of claim 12, wherein the instruction is one of a plurality of instructions of a current process and the endian control bits, the address space attributes, and the endian selection attribute are context-switchable with the current process.

14. The data processing engine of claim 1, wherein when the instruction accesses a first one and a second one of the address spaces simultaneously and addresses of the second address space are higher than those of the first address space, the endian control device outputs the endian control bit corresponding to either the first address space or the second address space, but not both, as the endian signal or the data processing engine raises an exception.
